(19) United States
(12) Patent Application Publication
(10) Pub. No.: US 2015/0324407 A1
(43) Pub. Date: Nov. 12, 2015

(54) METHOD FOR INDEXING GEOGRAPHICAL DATA

(71) Applicant: ISOGEO, PARIS (FR)

(72) Inventor: MATHIEU BECKER, PARIS (FR)

(21) Appl. No.: 14/388,233

(22) PCT Filed: Mar. 15, 2013
(86) PCT No.: PCT/EP2013/055438

§ 371 Date: Sep. 25, 2014

(30) Foreign Application Priority Data
Mar. 29, 2012 (FR) 12 52857

(51) Int. Cl. G06F 17/30

(52) U.S. Cl. CPC G06F 17/30339; G06F 17/30241

(57) ABSTRACT

A method for indexing geographical data by defining at least one input point allowing access to all or part of the geographical data stored in a storage place accessible from the input point. The input point is in the form of a root path, a uniform resource locator or a connection chain in accordance with the storage mode of the geographical data. Information layers containing at least one piece of geographical data in the storage place defined by the input point is detected. A reference index is constructed by adding into a table, for each detected information layer, a piece of metadata characterizing the detected information layer.

### TECHNICAL FIELD OF THE INVENTION

The invention relates to a method for indexing geographical data. The invention finds a particularly advantageous application in managing the geographical data of companies or local government authorities.

### PRIOR ART

Geographical data is witnessing a resurgence related to the development of computing means and to automation. For example, an automobile construction company may implement geo-location tracking of parts. Each part can be encompassed in a geographical layer containing semantic information about the part (size, weight, material, etc.) as well as geographical data on the part's storage site or sites (for example a longitude and a latitude).

A constant increase is thus being witnessed in regard to geographical data for modeling an environment. Moreover, these geographical data may be stored in a file, in a table of a database or else in a web service.

There also exist numerous geographical data formats related to the type of storage, for example the “shapefile”, “geodatabase” or “mifmid” (trademarks) formats. The plurality of these geographical data formats involves a plurality of different tools for managing geographical data, each tool being associated with one or more formats without encompassing the majority thereof.

A need exists to exploit geographical data assets by deploying a homogeneous exhaustive catalog of these geographical data regardless of format. The invention makes it possible to address this need.

### SUBJECT OF THE INVENTION

The invention consists of a method for indexing geographical data able to read the majority of the geographical data formats of a storage space and to construct a catalog of these data.

For this purpose, the invention relates to a method for indexing geographical data, characterized in that it comprises the following steps: defining at least one entry point making it possible to access all or some of the geographical data stored in a storage site accessible from said entry point, the entry point being able to take the form of a root path, of a uniform resource locator or of a connection chain as a function of the mode of storage of the item of geographical data, detecting, in the storage site defined by the entry point, information layers containing at least one item of geographical data, and constructing a reference index by adding into a table, for each information layer detected, an item of metadata characterizing this information layer.

According to one implementation, the method furthermore comprises a step of updating the reference index by comparing a temporary index with the reference index. This implementation makes it possible to create an up-to-date catalog of the geographical data.

According to one implementation, the step of detecting information layers comprises a step of analyzing the header of each element contained in the storage site. “Header of an element” is intended to mean a start portion of an element comprising information about the content of the element.

According to one implementation, the step of detecting information layers comprises a step of analyzing the extension of each element contained in the storage site. For example, the method can search for “.shp” extensions for elements in the “shapefile” format and “.dbf” extensions for elements in the “geodatabase” format.

According to one implementation, the step of detecting information layers comprises a step of analyzing the content of each element contained in the storage site.

According to one implementation, the item of metadata of a geographical information layer contains an item of information relating to the physical path for accessing said information layer. The catalog thus making it possible to provide access to the item of geographical data.

According to one implementation, the item of metadata of a geographical information layer contains an item of information relating to the footprint of the geographical data of the information layer. “Footprint of an item of geographical data” is intended to mean the shape and the position in space of the item of geographical data.

According to one implementation, the item of metadata of a geographical information layer contains semantic information describing the geographical data of the information layer. For example, for an information layer arising from a cadastre, the semantic information may be the name of the owner of a plot, the area of the plot and the date the plot was put up for sale.

According to one implementation, the item of metadata of a geographical information layer contains information relating to the number and to the type of entities in the information layer. The type of an entity may be: point-like for example for an information layer describing the disposition of the trees of a park, linear for example for an information layer describing an electrical network, or areal for example for an information layer describing cadastral plots.

According to one implementation, the item of metadata of a geographical information layer contains a characteristic key of the information layer. The key being calculated as a function of the information contained in the information layer, it makes it possible to detect a modification of the information layer by measuring the difference between a current key and an earlier key. The key may be for example a hashing key for the geographical information layer.

According to one implementation, the item of metadata of a geographical information layer is formulated according to the ISO 19 115 standard. This standard abstracts from defined content all the information that it is possible to make available to describe the item of data while organizing said information by classes. It exhibits the advantage of allowing modification and extension of the item of metadata. Moreover, the ISO 19 115 standard has asserted itself as a reference for geographical information in the field of metadata.

### BRIEF DESCRIPTION OF THE FIGURES

The invention will be better understood on reading the description which follows and on examining the figures which accompany it. These figures are given merely by way of wholly non-limiting illustration of the invention. They show:

FIG. 1: a representation of a cadastral geographical layer as well as the corresponding information;

FIG. 2: a schematic representation of the steps of the method for indexing geographical data according to an embodiment of the invention;

FIG. 3: a schematic representation of the interactions between an agent and a remote server of the invention;

FIG. 4: a schematic representation of a chain for processing geographical data according to the invention.

Identical, similar or analogous elements retain the same references from one figure to another.

### DESCRIPTION OF EXEMPLARY EMBODIMENTS OF THE INVENTION

FIG. 1 shows an exemplary areal geographical layer 19 bearing the name 23: “City of Paris cadastral layer”. The cadastral layer 19 contains ten entities 30-39 representing land plots. The number 24 of entities 30-39 as well as the name 23 of the geographical layer 19, its type 25 and its attributes 26 are cataloged in a summary file 28 of the geographical layer 19. A geographical layer may be of areal, point-like or linear type.

The footprint of the geographical layer is defined by the rectangle 20 encompassing all the geographical entities 30-39, as a variant the footprint can take any shape other than a rectangle. Each entity 30-39 is described by geographical data 42 making it possible to define, for example, its shape and its coordinates. These geographical data 42 are stored in a descriptive file 29 of the geographical layer 19. The descriptive file 29 also comprises some information about the entities 30-39 such as the index number of the entity, the name of the owner, the year of purchase or else the area of the entity. Such information is referred to as the attributes 26 of the geographical layer 19.

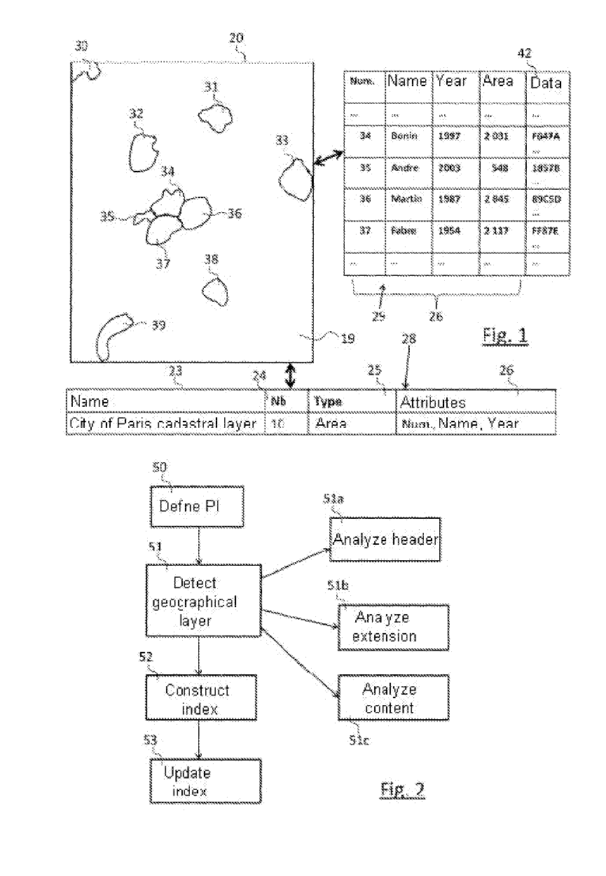

The method of the invention, described in FIG. 2, comprises a first step 50 of defining entry points PI. These entry points PI make it possible to access all or some of the geographical data 42 stored in a storage site 60-62 which is accessible from the entry point PI. The storage site 60-62 can be a computer or a server containing files 60, the entry point PI then takes the form of a root path for example of the type “D://Data/Town hall/Parks”. The storage site 60-62 can also be a database 61, the entry point PI then takes a tree-like form of the type: name of the server, name of the base and then name of the instance. The storage site 60-62 can be an Internet service, the entry point PI then takes the form of a uniform resource locator (also called a “URL”).

From this entry point PI, the method of the invention searches for and detects 51 the geographical layers 19 that are accessible from the entry point PI. Detection 51 can be performed by an analysis of the header 51a and/or an analysis of the extension 51b and/or an analysis of the content 51c of the elements accessible from the entry point PI. FIG. 3 shows that this detection step 51 can be performed by an agent 58 embedded at a client 56, for example a local government authority.

These geographical data 42 detected 51 are then indexed in the form of item of metadata in a reference index 80 constructed 52 on a database 66. The database 66 can be disposed on a remote server 55 accessible from an Internet service 65. The item of metadata of a geographical information layer 19 contains various items of information such as:
the physical path for accessing the information layer 19,
the footprint of the geographical data 42,
the semantic information describing the item of geographical data 19, for example the attributes 26,
the number 24 and the types 25 of entities 30-39,
a control key for the information layer 19.

Preferably, the item of metadata is formulated according to the ISO 19 115 standard and more particularly by the ISO 19 139 standard defining a standardized implementation in the XML format (for “Extensible Markup Language”).

FIG. 3 shows that when the agent 58 detects 51 a new geographical layer 19, a new information line is created 68 in the database 66. The various information lines of the database 66 make it possible to generate a reference index 80 for the geographical data 42. The control key for the information layer 19 makes it possible to detect a modification of a geographical layer 19 by comparing 69 the key of a temporary index 90 disposed on the agent 58 with the key of the reference index 80 disposed on the database 66. The detection of a modification of the information layer 19 can bring about an addition 70 or a deletion 71 in the reference index 80. When the agent 58 to terminate the geographical layer 19 search, the temporary index 90 can be updated by dispatching the reference index 80 to the agent 58.

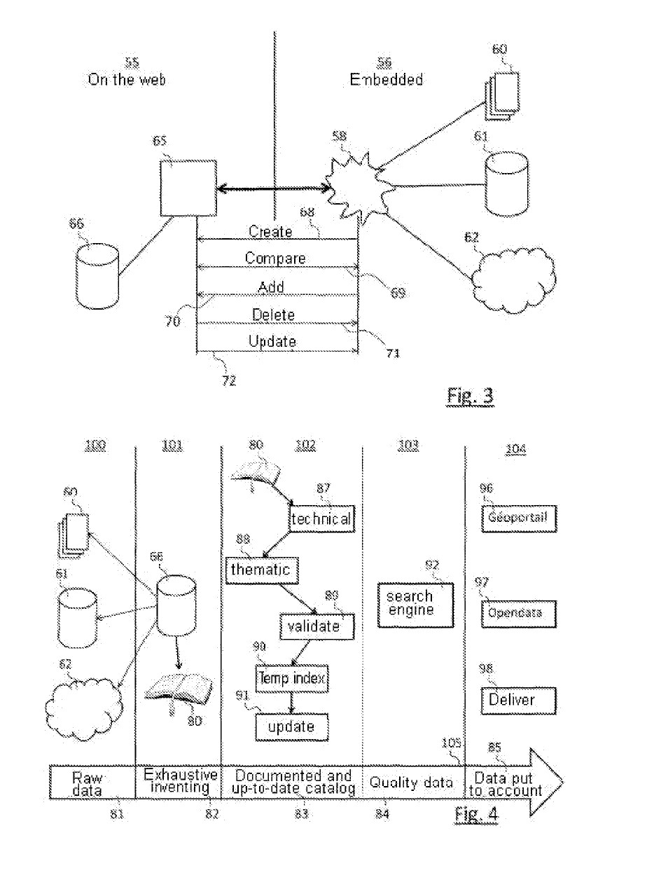

FIG. 4 shows the evolution 105 of the geographical data 42 during the implementation of the method of the invention. In the first phase 100, the geographical data 42 are raw data 81 and are stored in at least one storage site 60-62. Phase 101 uses the step 50 of defining at least one entry point PI and the geographical layer 19 detection step 51 to construct 52 the reference index 80. Phase 101 can be repeated several times and makes it possible to obtain an exhaustive inventory of the geographical data 42 of one or more organizations, government authorities or companies.

Phase 102 describes the reprocessing of the metadata of the reference index 80. The metadata of the reference index 80 can be completed 87 by technical personnel with the aid of a user interface. The technical personnel can thus add 70 an item of information that is not present in the attributes such as the date of updating of the geographical layer 19. The metadata can also be classed 88 thematically so as to facilitate their utilization. Moreover, the metadata can be validated 89 by an algorithm or an operator so as to retain only the geographical information layers 19 exhibiting a utility, the criterion of utility of a geographical information layer 18 being defined as a function of an application. The agent 58 can also generate a temporary index 90 so as to update 91 the reference index 80. All these operations of phase 102 make it possible to obtain a documented and up-to-date catalog 83.

Phase 103 describes a processing of the reference index 80 so as to facilitate its utilization. A search engine 92 is created to scan through the reference index 80 as a function of diverse criteria such as:
a geographical zone for searching for geographical data 42, for example by selection on an interactive map,
a center of interest, for example of gas pipelines,
a data format, or
all the categories specified by the INSPIRE directive. The INSPIRE directive making it possible to establish a geographical information infrastructure in the European Community, for the purposes of community environmental policies and policies or activities of the Community that are liable to have an impact on the environment.

The user of the search engine 92 can search and navigate in the reference index 80. “Navigate” is intended to mean the possibility of going from one item of geographical data 42 to another item of geographical data.

Phase 104 describes the dissemination of the geographical data 42 so as to turn them to account 85 outside the organization. In this phase 104, the geographical data 42 are exported to software such as Géoportail 96 or Opendata 97 (trademarks). The geographical data 42 can also be exported by any other means of delivery 98. For example, on the basis of the reference index 80, it is possible to generate a standardized catalog in the form of an Internet service allowing interoperability with existing tools such as for example GEOSOURCE, ESRI or any other equivalent standardized tool utilizing in particular the format of the standardized catalog. The standardized catalog is typically formulated with the CSW (“Catalogue Services for the Web”) standard developed by the OGC (“Open Geospatial Consortium”).

The invention exhibits the advantage of generating a documented and up-to-date exhaustive index of a set of geographical data 42 that can belong to a multitude of geographical layers 19. Moreover, the invention offers the possibility of accessing the item of geographical data 42 via the access path stored in the associated item of metadata thus making it possible to extract it, for example, with the aim of representing it graphically, of delivering it to a client, or of utilizing it to compile a map.

1-11. (canceled)

12. A method for indexing geographical data, comprising the steps of:
defining at least one entry point to access all or some of the geographical data stored in a storage site accessible from the entry point taking a form of a root path, a uniform resource locator or a connection chain as a function of a storage mode of an item of geographical data;
detecting, in the storage site defined by the entry point, geographical information layers comprising at least one item of geographical data; and
constructing a reference index by adding into a table, for each geographical information layer detected, an item of metadata characterizing said each geographical information layer.

13. The method as claimed in claim 12, further comprising the step of updating the reference index by comparing a temporary index with the reference index.

14. The method as claimed in claim 12, wherein the step of detecting comprises the step of analyzing a header of each element in the storage site.

15. The method as claimed in claim 12, wherein the step of detecting comprises the step of analyzing an extension of each element in the storage site.

16. The method as claimed in claim 12, wherein the step of detecting comprises the step of analyzing content of each element in the storage site.

17. The method as claimed in claim 12, wherein the item of metadata of a geographical information layer comprises an item of information relating to a physical path for accessing the geographical information layer.

18. The method as claimed in claim 12, wherein the item of metadata of a geographical information layer comprises an item of information relating to a footprint of the geographical data of the geographical information layer.

19. The method as claimed in claim 12, wherein the item of metadata of a geographical information layer comprises semantic information describing the geographical data of the geographical information layer.

20. The method as claimed in claim 12, wherein the item of metadata of a geographical information layer comprises information relating to a number and types of entities in the geographical information layer.

21. The method as claimed in claim 12, wherein the item of metadata of a geographical information layer comprises a characteristic key of the geographical information layer.

22. The method as claimed in claim 12, wherein the item of metadata of a geographical information layer is formulated according to an ISO 19 115 standard.
